(19) United States
(12) Patent Application Publication
(10) Pub. No.: US 2026/0147829 A1
(43) Pub. Date: May 28, 2026

(54) NATURAL DISASTER DAMAGE ANALYSIS

(71) Applicant: NEC Laboratories America, Inc., Princeton, NJ (US)

(72) Inventors: Biplob Debnath, Princeton, NJ (US); Ravi Kailasam Rajendran, Colonia, NJ (US); Murugan Sankaradas, Dayton, NJ (US); Srimat Chakradhar, Manalapan, NJ (US)

(21) Appl. No.: 19/396,962

(22) Filed: Nov. 21, 2025

Related U.S. Application Data
(60) Provisional application No. 63/725,764, filed on Nov. 27, 2024.
(60) Provisional application No. 63/756,427, filed on Feb. 10, 2025.
(60) Provisional application No. 63/811,032, filed on May 23, 2025.

(51) Int. Cl. G06F 16/55; G06F 16/51; G06F 16/56

(52) U.S. Cl. CPC G06F 16/55; G06F 16/51; G06F 16/56

(57) ABSTRACT

Systems and methods for natural disaster damage analysis. Aerial images are converted into a set of property images. The property images are then clustered using vector embedding. Clustering the property images includes classifying the property images into separate categories, determining a symmetric similarity between the property images in each category, and clustering the property images based on the similarity. A first artificial intelligence agent extracts damage information from a set of representative members of the clustered property images, where the damage information includes damage level information and damage reasoning information. The damage information is then stored in a datastore with at least two databases, where at least one of the databases stores damage reasoning information and at least one other one of the databases stores damage level information.

### RELATED APPLICATION INFORMATION

This application claims priority to U.S. Provisional Patent Application Nos. 63/725,764, filed on Nov. 27, 2024, 63/756,427, filed on Feb. 10, 2025, and 63/811,032, filed on May 23, 2025, incorporated herein by reference in their entirety.

### BACKGROUND

### Technical Field

The present invention relates to systems and methods for natural disaster damage analysis and more particularly to systems and methods for remote natural disaster damage analysis.

### Description of the Related Art

Natural disasters cause extensive damage to residential areas. However, it is often difficult to survey the damaged areas in person. Thus, there is a need for a remote way to assess damage after a natural disaster.

### SUMMARY

According to an aspect of the present invention, a method is provided for converting a set of aerial images into a set of property images, clustering the set of property images using vector embedding, wherein clustering includes classifying the property images into separate categories, determining a symmetric similarity between the property images in each category, and clustering the property images based on the similarity, extracting, by a first artificial intelligence (AI) agent, damage information from a set of representative members of the clustered property images, wherein the damage information includes damage level information and damage reasoning information, and storing the damage information into a datastore with at least two databases, wherein at least one of the databases stores damage reasoning information and at least one other one of the databases stores damage level information.

According to another aspect of the present invention, a system for natural disaster damage analysis is provided, the system comprising a processor, and a memory storing computer-readable instructions that, when executed by the processor, cause the system to convert a set of aerial images into a set of property images, cluster the set of property images using vector embedding, wherein cluster includes, classify the property images into separate categories, determine a symmetric similarity between the property images in each category, and cluster the property images based on the similarity, extract damage information from a set of representative members of the clustered property images, wherein the damage information includes damage level information and damage reasoning information, and store the damage information into a datastore with at least two databases, wherein at least one of the databases stores damage reasoning information and at least one other one of the databases stores damage level information.

According to another aspect of the present invention, a computer program product is provided, the computer program product comprising a non-transitory computer-readable storage medium containing computer program code, the computer program code when executed by one or more processors causes the one or more processors to perform operations, the computer program code comprising instructions to convert a set of aerial images into a set of property images, cluster the set of property images using vector embedding, wherein cluster include classify the property images into separate categories, determine a symmetric similarity between the property images in each category, and cluster the property images based on the similarity, extract, by a first artificial intelligence (AI) agent, damage information from a set of representative members of the clustered property images, wherein the damage information includes damage level information and damage reasoning information, and store the damage information into a datastore with at least two databases, wherein at least one of the databases stores damage reasoning information and at least one other one of the databases stores damage level information.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system and method for natural disaster damage analysis, in accordance with an embodiment of the present invention;

FIG. 2 is a diagram illustrating a practical application, in accordance with an embodiment of the present invention;

FIG. 3 is a block/flow diagram illustrating a method for natural disaster damage analysis, in accordance with an embodiment of the present invention;

FIG. 4 is a diagram illustrating a clustering component, in accordance with an embodiment of the present invention;

FIG. 5 is a diagram illustrating a before and after picture analysis, in accordance with an embodiment of the present invention;

FIG. 6 is a block/flow diagram illustrating a system for natural disaster damage analysis, in accordance with an embodiment of the present invention; and

FIG. 7 is a block/flow diagram illustrating a method for natural disaster damage analysis, in accordance with an embodiment of the present invention.

### DETAILED DESCRIPTION OF PREFERRED EMBODIMENTS

In accordance with embodiments of the present invention, systems and methods are provided for natural disaster damage analysis.

In an embodiment, a method is provided for converting a set of aerial images into a set of property images, clustering the set of property images using vector embedding, wherein clustering includes classifying the property images into separate categories, determining a symmetric similarity between the property images in each category, and clustering the property images based on the similarity, extracting, by a first artificial intelligence (AI) agent, damage information from a set of representative members of the clustered property images, wherein the damage information includes damage level information and damage reasoning information, and storing the damage information into a datastore with at least two databases, wherein at least one of the databases stores damage reasoning information and at least one other one of the databases stores damage level information.

In an embodiment, a system for natural disaster damage analysis is provided, the system comprising a processor, and a memory storing computer-readable instructions that, when executed by the processor, cause the system to convert a set of aerial images into a set of property images, cluster the set of property images using vector embedding, wherein cluster includes, classify the property images into separate categories, determine a symmetric similarity between the property images in each category, and cluster the property images based on the similarity, extract damage information from a set of representative members of the clustered property images, wherein the damage information includes damage level information and damage reasoning information, and store the damage information into a datastore with at least two databases, wherein at least one of the databases stores damage reasoning information and at least one other one of the databases stores damage level information.

In an embodiment, a computer program product is provided, the computer program product comprising a non-transitory computer-readable storage medium containing computer program code, the computer program code when executed by one or more processors causes the one or more processors to perform operations, the computer program code comprising instructions to convert a set of aerial images into a set of property images, cluster the set of property images using vector embedding, wherein cluster include classify the property images into separate categories, determine a symmetric similarity between the property images in each category, and cluster the property images based on the similarity, extract, by a first artificial intelligence (AI) agent, damage information from a set of representative members of the clustered property images, wherein the damage information includes damage level information and damage reasoning information, and store the damage information into a datastore with at least two databases, wherein at least one of the databases stores damage reasoning information and at least one other one of the databases stores damage level information.

The present embodiments address the problem of efficiently assessing the cost of destruction after a natural disaster. The present embodiments use aerial images to determine the cost of destruction. Aerial images are useful because they can be obtained without physically being at the site. The present embodiments then convert the aerial images into property images which are then processed by a multi-modal large language model. The processed information can then be stored in a database where the information can later be retrieved using a Retrieval Augmented Generation (RAG) framework.

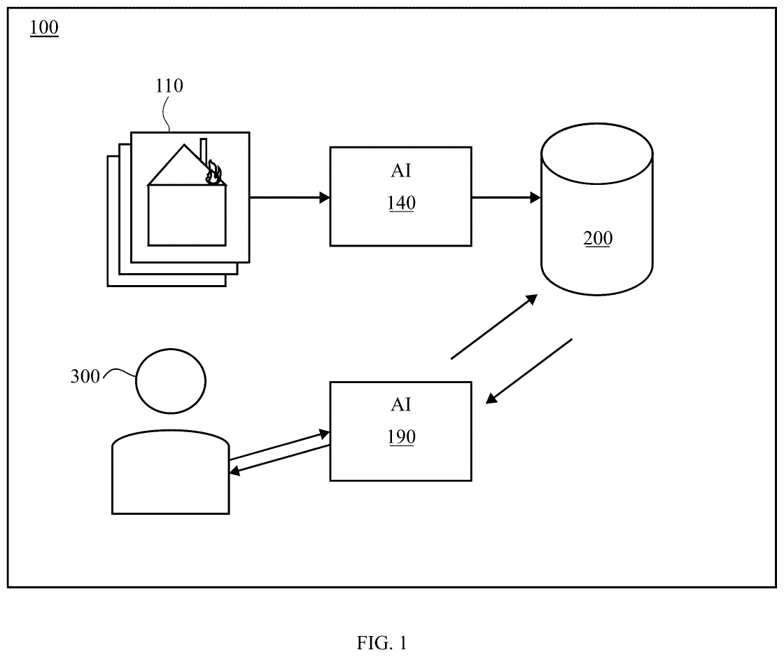

FIG. 1 is a high-level overview of an embodiment. Referring to FIG. 1, a system and method 100 provide a way to analyze damage after a natural disaster. Aerial images 110 are obtained and processed by a first AI agent 140 to extract damage information. The first AI agent 140 can be a multimodal large language model (LLM). The damage information is then stored in a data store 200. Then a user 300 can ask a second AI agent 190 a question about the damage. The second AI agent 190 uses the user's question to retrieve data from the data store 200. The second AI agent 190 can also be multi-modal. The second AI agent 190 uses the retrieved data to supplement the second AI agent's 190 response 191 to the user 300.

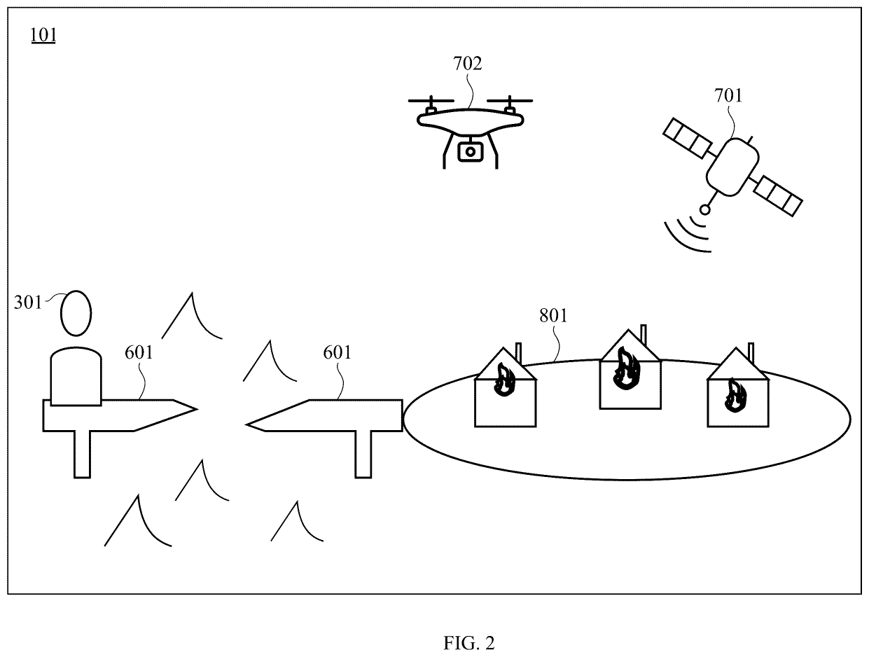

A practical application can include remote analysis of a scene after a natural disaster to determine the extent of the damage. This is beneficial because natural disasters often take out key infrastructure that prevent one from arriving at a scene for damage assessment. Referring to FIG. 2, in a practical scenario 101, individual 301 cannot reach the island 801 due to a natural disaster destroying bridge 601. To resolve this practical scenario 101, aerial images can be used to assess the amount of damage. These aerial images can be obtained from a device such as a satellite 701 or a drone 702.

Another practical application can include having the aerial images are obtained from a drone passing by the disaster scene.

Another practical application can include having the aerial images analyzed to determine the quality of the land. For example, a farmer could have the aerial images analyzed to determine if the plot is suitable for growing crops.

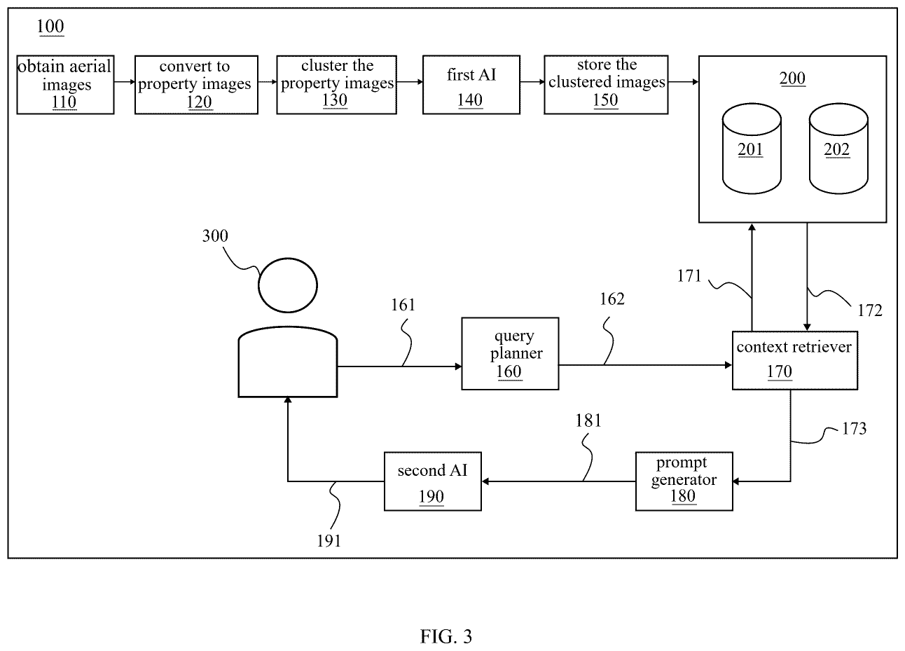

Referring now in detail to the figures in which like numerals represent the same or similar elements and initially to FIG. 3, a system and method 100 for analyzing aerial images after a disaster is illustratively depicted in accordance with one embodiment of the present invention. The system and method 100 can include a block 110 for obtaining aerial images. The aerial images can be obtained by a user or through any external source, such as by a satellite or drone.

After the aerial images are obtained, the aerial images are converted at block 120 to property images. The aerial images can be converted using property metadata, such as geographical boundaries and property records, to isolate individual properties within an observed image. After the aerial images are converted to property images, the property images are clustered at block 130. A benefit to clustering is the speeding up of processing the images. For example, it would be beneficial to process a hundred clusters of property images rather than processing 10,000 individual property images. This is relevant because after a natural disaster, thousands of property images have to be processed to accurately assess the damage. Having an artificial intelligence (AI) agent process each image is resource intensive. Thus, clustering reduces the burden on an AI agent by clustering the property images together based on similar characteristics and allowing the AI agent to process each cluster at a time instead of each individual image. Furthermore, the system and method 100 in FIG. 3 allows a generic computer to process images quicker, thus resulting an improvement in function of the generic computer.

After the property images are clustered, a set of representative members of the clustered property images are processed by a first AI agent 140 for damage information. The representative members can be selected randomly or selected based on their proximity to the rest of the cluster. For example, a representative could be the closest member to the rest of the cluster.

The first AI agent 140 can be a multi-modal large language model (LLM). The first AI agent 140 can be trained to evaluate various damage metrics to provide a comprehensive damage description, including deep learning techniques. For example, the first AI agent 140 assesses roof damage by analyzing the structural integrity, discoloration, or visible debris on roof tops. The first AI agent 140 can assess structural damage by analyzing any visible deformation, collapses, or breaches in the building's infrastructure. The first AI agent 140 can examine lawn damage by detecting scorch marks, erosion, or flooding. The first AI agent 140 can conduct water damage analysis by identifying potential flooding or water accumulation on the property. The first AI agent 140 can inspect the image for fire and smoke damage, flagging any burn marks or smoke-related deterioration visible in the image. The first AI agent 140 can estimate the occupiable status of the property, determining whether it is safe and habitable based on the level of destruction. The first AI agent 140 can also provide an estimate of the man-hours needed for on-site inspection.

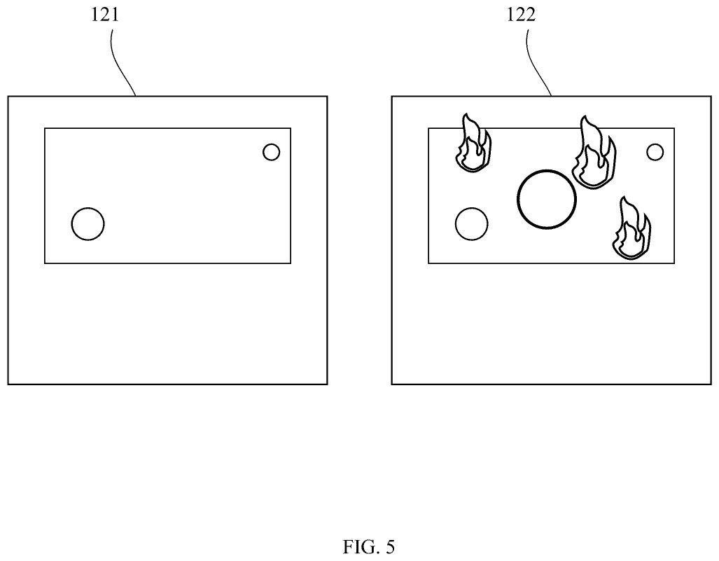

Referring to FIG. 5, to determine damage, the first AI agent 140 can rely on historical data such as previous pictures of the property. For example, the first AI agent 140 can rely on a previous property image 121. The first AI agent 140 can obtain the previous property image 121 by using property metadata. For example, the first AI agent 140 can obtain the previous property image 121 by using the property records. Then first AI agent 140 can compare the previous property image 121 with a converted property image 122. The first AI agent 140 can determine that the previous property image 121 had roof damage such as two small holes. Thus, the first AI agent 140 can determine that those exact holes in the converted property image 122 are not new. Then the first AI agent 140 can determine that a larger hole and fire damage in the converted property image 122 are new because those damages do not exist in previous property image 121. Thus, when assessing the roof damage from a natural disaster, the first AI agent 140 can disregard the previous two small holes and only consider the large hole and the fire damage.

The first AI agent 140 can provide a damage level, based on the severity of the damage. For example, the first AI agent 140 can provide a roof damage level based on the number of roof shingles missing. The damage level can be considered damage level information, while the reasoning behind the type of damage and the specific details can be considered damage reasoning information. Continuing with our previous example, the damage level information would be the roof damage level while the explanation for the roof damage level (number of roof shingles missing) can be considered damage reasoning information. The damage level information can be encoded as structural metadata, while the damage reasoning information can be encoded as vectors.

The first AI agent 140 can then send the damage information to a storing component 150 which stores the damage information into data store 200. The data store 200 can have at least two separate databases 201, 202. For example, one database 201 can be a structured query language (SQL) database while the other 202 can be a vector database. One of the databases 201 can store damage level information, while the other one 202 can store damage reasoning information.

By separating the damage information and storing it into at least two different databases, the damage information will become quicker and easier to retrieve. Most queries can typically be classified as either requiring damage level information or damage reasoning information. Thus, separating and storing the damage information based on the types of queries makes the information retrieval process more efficient. For example, with database 201 being a SQL database storing the damage level information as structured metadata, the database 201 can enable fast indexing and precise operations such as “filter all properties with damage_level >2” or “list properties with structural damage.” In contrast, the database 202 is storing the damage reasoning information as vectors. The database 202 can use store using semantic index, allowing for open ended queries such as “find properties with signs of roof shingle loss” or “retrieve all houses described as uninhabitable.”

By speeding up the information retrieval process, the data store 200 can allow for scalable storage and retrieval. This is beneficial when dealing with large amounts of datasets, like aerial images after a natural disaster. Furthermore, it provides less information to an AI agent trained to retrieve information from the data store 200 which decreases the chances of confusion.

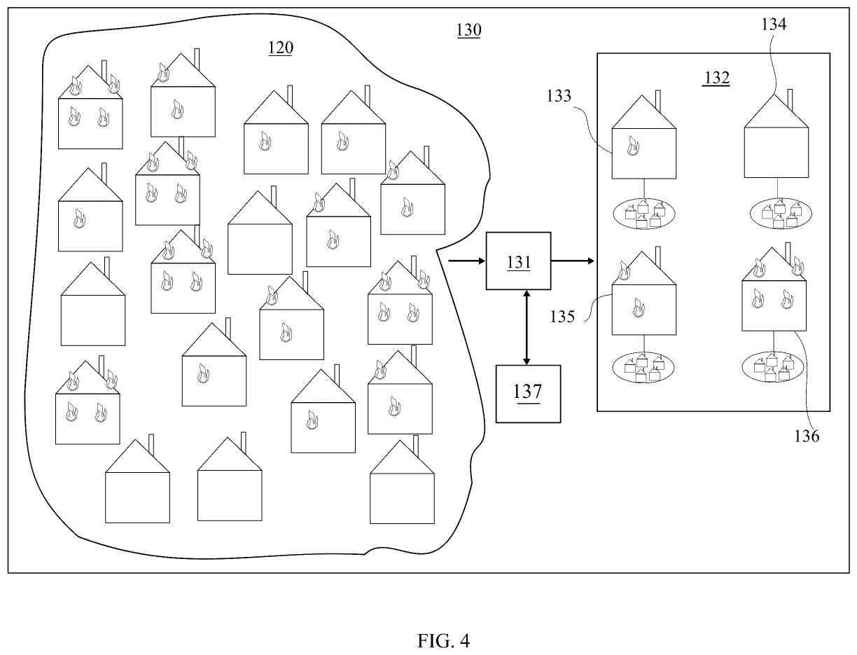

Referring to FIG. 4, during the clustering block 130, the property images are sent to a clustering component 131. As previously mentioned, the clustering component 131 allows for the speeding up of processing images. The clustering component 131 can classify the property images into categories 132. Specifically, the clustering component 131 can classify the property images into no damage 133, minor damage 134, major damage 135, and destroyed 136. The clustering component 131 then ignores the no damage 133 category and focuses on the other three categories. The classification reduces heterogeneity by partitioning images into coarse severity groups, creating more homogeneous subsets for clustering. Applying clustering only within non-zero classes then reveals coherent, fine-grained damage patterns that would be obscured in a single global clustering step. By classifying first, this reduces noise, improves cluster stability, and avoids unnecessary computation for undamaged properties, enabling more interpretable and scalable analysis.

In an embodiment, the clustering component 131 categorizes the property images using keyword matching and embeddings. The clustering component 131 can maintain at least two sets of pre-defined keywords. One set is damage-related keywords such as “debris,” “damaged roof,” and “destroyed house.” The other set is non-damage keywords such as “well-maintained house,” “intact structure,” and “pristine condition.” The clustering component 131 can then use vision language models to generate embeddings for the property images and keyword sets. For example, the clustering component 131 can use a vision language model 137 like Contrastive Language-Image Pre-Training (CLIP) or embedding systems like CLIP to generate embeddings for the property images and the keyword sets. The vision language model 137 can be trained with a dataset. For example, a training dataset can be a large corpus of pre- and post-disaster aerial imagery annotated with damage level labels.

In an embodiment, the clustering component 131 can use the first AI agent to generate embeddings.

Then the clustering component 131 determines a similarity score between each property image embedding and each keyword set. These similarity scores measure how closely the visual features in the property image align with the semantic meaning of the keywords. The similarity score can be averaged for each keyword set to create an overall score for damage and non-damage. The clustering component 131 then compares the overall damage score and overall non-damage score to determine the classification based on which is higher. For example, if the overall damage score is higher than the overall non-damage score, then the clustering component 131 can classify the property image into minor damage 134, major damage 135, or destroyed 136. If the overall damage score is lower than overall non-damage score, then the clustering component 131 classifies the property image as no damage 133. In an embodiment, the clustering component 131 classifies the property image into two categories: no damage and damage.

In an embodiment, if the overall damage score is higher than the overall non-damage score, then the clustering component 131 can classify the property image based off how much the overall damage score is higher than the non-damage score. For example, minor damage 134, major damage 135, and destroyed 136 reflect how much the overall damage score is higher than the non-damage score, with minor damage 134 being the smallest gap and destroyed 136 being the largest gap.

In another embodiment, the classification can be determined by using labeled data. For example, the vision language model 137 can be trained with labeled data to recognize property images as having a category of damage.

For the remaining categories, a more nuanced understanding of the damage is needed. In an embodiment, the clustering component 131 first receives a number for the number of clusters in each damages category. For the number of clusters, it is advantageous to use the square root of the number of properties in each category due to yielding more semantically meaningful groupings and mitigates overfitting in sparse cases.

In an embodiment, the clustering component 131 can use multi-vector embeddings. The clustering component 131 can use a vision language model such as CLIP to generate multi-vector embeddings, where each property image is represented as a set of token-level vectors. Multi-vector embedding can preserve contextual nuance and improve performance in retrieval tasks.

To find similarities between the property image and preserve accuracy while using multi-vector embeddings, the clustering component 131 can use a symmetric similarity function compatible with multi-vector embedding. The symmetric similarity function can be represented as an average such as:

$$Max {Sim}_{symmetrical} ( A , B ) = \frac{1}{2} * [ ( \frac{1}{m} ) * {\sum }_{i} {max}_{j} sim ( {a}_{i ,} {b}_{j )} + ( \frac{1}{n} ) * {\sum }_{j} {max}_{i} sim ( {b}_{j} {a}_{i} ) ]$$

wherein, A={a₁, a₂, . . . , aₘ} and B={b₁, b₂, . . . , bₙ}.

In an embodiment, after determining the symmetric similarity function, the clustering component 131 can use hierarchical agglomerative clustering. The hierarchical agglomerative clustering can be accomplished with a distance metric such as:

$$Distance = 1 - Max {Sim}_{symmetrical}$$

Then a representative member from each cluster is sent to be processed by the first AI agent.

In an embodiment, the clustering component 131 can use single vector embedding. Continuing with this embodiment, the clustering component can use a K-means clustering algorithm. In another embodiment, the clustering component 131 can use a density-based clustering algorithm such as DBScan.

In an embodiment, the clustering component 131 can use K-Nearest Neighbors (K-NN) clustering algorithm. Continuing with this embodiment, the clustering component 131 uses a predetermined sample size of property images to generate labeled data. The number of samples can be determined by using a coupon collection method, with each coupon corresponding to one of the previously mentioned damage classes (no damage, minor damage, major damage, destroyed). The labeled data is fed to a multimodal large language model to generate detailed damage metrics with reasoning. For the remaining property images, the most similar sampled property image is identified and assigned the corresponding damage assessment.

Referring back to FIG. 3, the method 100 uses a Retrieval-Augmented Generation (RAG) framework to respond to a user 300. First, a user 300 sends 161 a query to a query planner 160. The query planner 160 can parse the query and plan for a semantic search, a structured language (such as SQL) search, or both. The query planner 160 may leverage an LLM to parse the query. The benefit of the query planner 160 is to ensure only the necessary data is retrieved from the data store 200. Otherwise, second AI agent 190 would have to process the entire data set stored in data store 200 for every query from the user 300.

The query planner 160 sends 162 the plan containing the original query from step 161 to the context retriever 170. The context retriever 170 uses the plan from the query planner 160 to send another query 171 to the data store 200. The context retriever 170 can use the plan to determine which database in the data store 200 to access. For example, the context retriever 170 can use the plan to determine that damage reasoning information is needed and sends a query to the corresponding database 202. The data store 200, based on the query, sends 172 the relevant data to the context retriever. The context retriever 170 then sends 173 the relevant data and the original query to the prompt generator 180.

Using the relevant data and the original query, the prompt generator 180 sends 181 a prompt with the relevant data and the original query attached to a second AI agent 190. The prompt can consist of three elements: an original query, a retrieved context, and instructional guidance. The original query may be rephrased for clarity. The retrieved data is detailed data from the data store 200 that directly pertains to the original query. Examples of detailed data include specific damage metrics, summaries of affected areas, and historical information about the properties. The instructional guidance is additional directives given to the second AI agent 190 to ensure that the response is formatted, structure, or summarized according to the needs of the user 300. For example, the instruction might include, “Summarize the data across multiple properties,” or “Provide a detailed analysis focusing only on roof damage.” The second AI agent 190 can be a large language model. Using the prompt, the second AI agent 190 can then respond to the user 300.

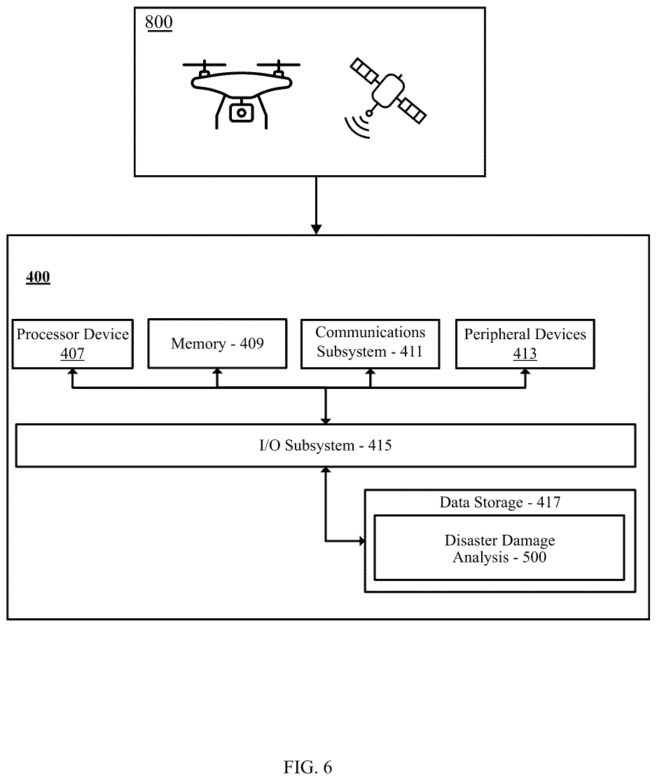

Referring now to FIG. 6, a block diagram of a computer system for subgroup discovery for survival analysis, in accordance with an embodiment of the present invention.

In an embodiment, the computing device 400 can be implemented as the method 100. The computing device 400 illustratively includes the processor device 407, the input/output (I/O) subsystem 415, the memory 409, the data storage device 417, and the communications subsystem 411, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 409, or portions thereof, may be incorporated in the processor device 407 in some embodiments.

The processor device 407 may be embodied as any type of processor capable of performing the functions described herein. The processor device 407 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 409 may be embodied as any type of volatile or non-volatile memory or data storage capable of performing the functions described herein. In operation, the memory 409 may store various data and software employed during operation of the computing device 400, such as operating systems, applications, programs, libraries, and drivers. The memory 409 is communicatively coupled to the processor device 407 via the I/O subsystem 415, which may be embodied as circuitry and/or components to facilitate input/output operations with the processor device 407, the memory 409, and other components of the computing device 400. For example, the I/O subsystem 415 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 415 may form a portion of a system-on-a-chip (SOC) and be incorporated, along with the processor device 407, the memory 409, and other components of the computing device 400, on a single integrated circuit chip.

The data storage device 417 may be embodied as any type of device or devices configured for short-term or long-term storage of data such as, for example, memory devices and circuits, memory cards, hard disk drives, solid state drives, or other data storage devices. The data storage device 417 can store program code for disaster damage analysis 500. Any or all of these program code blocks may be included in a given computing system.

The communications subsystem 411 of the computing device 400 may be embodied as any network interface controller or other communication circuit, device, or collection thereof, capable of enabling communications between the computing device 400 and other remote devices over a network. The communications subsystem 411 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 413. The peripheral devices 413 may include any number of additional input/output devices, interface devices, and/or other peripheral devices. For example, in some embodiments, the peripheral devices 413 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 400 are readily contemplated by one of ordinary skill in the art given the teachings of the present invention provided herein.

The computing device 400 may be coupled with a device 800 for taking aerial images. Examples include a satellite and a drone. The device 800 may send the aerial images to the computing device 400. For example, the device 800 can communicate with communications subsystem 411 via Wi-Fi® or Ethernet.

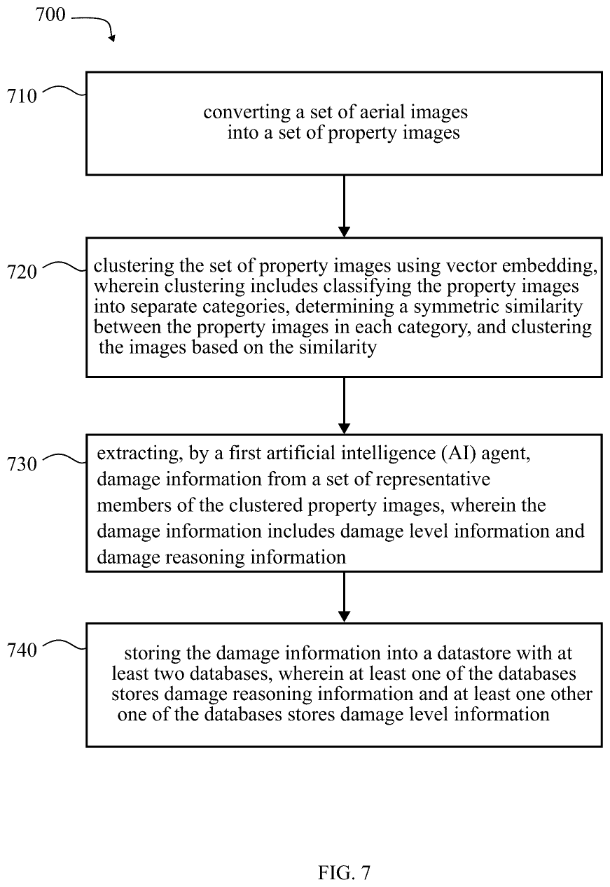

Referring to FIG. 7, a method 700 for natural disaster damage analysis is shown. The method 700 can use aerial images provided by a satellite, drone or equivalent to determine the damage level of an area struck by a natural disaster. The advantage of this method 700 is that by using aerial images, one does not need to be physically present at the location to analyze the extent of the damage. This is beneficial when key infrastructure is destroyed and one can only remotely analyze the extent of the damage in the area.

The method 700 is shown with a block 710 of converting a set of aerial images into a set of property images. The aerial images can be obtained from a satellite or a drone. The set of aerial images can be converted into a set of property images using property metadata. One example of property metadata is property records. The method 700 then has a block 720 of clustering the set of property images using vector embedding. The clustering can be accomplished with multi-vector embedding or single vector embedding. If multi-vector embedding is used, then each property image can be represented as a set of token level vectors.

The clustering can include classifying the property images into separate categories, determining a symmetric similarity between the property images in each category, and clustering the property images based on the similarity. There can be four categories, with the categories being: no damage, minor damage, major damage, and destroyed. The classifying can include converting the property image into an embedding, converting a first category of keywords and a second category of keywords into embeddings, generating a similarity score for each category of keywords and between each category of keywords embedding and the property image embedding, and filtering the property image if similarity score meets a threshold. The first category of keywords can include damage keywords and the second category of keywords can include non-damage keywords. The classifying threshold can be whether the similarity score for non-damage keywords is higher than the similarity score for damage keywords. The clustering can be accomplished with hierarchical agglomerative clustering.

The method 700 then has a block 730 for extracting, by a first artificial intelligence (AI) agent, damage information from a set of representative members of the clustered property images, wherein the damage information includes damage level information and damage reasoning information. The first AI agent can be a multimodal AI. The damage level information could be a general damage level and cost while the damage reasoning information would be the specific details that support the damage level information. For example, the damage level information could be the roof damage while the damage reasoning information could be the number of missing roof shingles.

Then the method 700 then has a block 740 for storing the damage information into a datastore with at least two databases, wherein at least one of the databases stores damage reasoning information and at least one other one of the databases stores damage level information. One database can be an SQL database that stores the damage level information while the other database can be a vector database that stores damage reasoning information.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for natural disaster damage analysis comprising:
converting a set of aerial images into a set of property images; clustering the set of property images using vector embedding, wherein clustering includes:
classifying the property images into separate categories;
determining a symmetric similarity between the property images in each category; and
clustering the property images based on the similarity;
extracting, by a first artificial intelligence (AI) agent, damage information from a set of representative members of the clustered property images, wherein the damage information includes damage level information and damage reasoning information; and
storing the damage information into a datastore with at least two databases, wherein at least one of the databases stores damage reasoning information and at least one other one of the databases stores damage level information.

2. The method of claim 1, further comprising:
processing, by a query planner, a query from a user;
retrieving from the datastore using the processed information;
generating a prompt with the retrieved information and the query attached to the prompt; and
generating, by a second AI agent, a response using the prompt and the retrieved information and the query.

3. The method of claim 1, wherein the clustering is done by hierarchical agglomerative clustering.

4. The method of claim 1, wherein the classifying includes:
converting the property image into an embedding;
converting a first category of keywords and a second category of keywords into embeddings;
generating a similarity score for each category of keywords and between each category of keywords embedding and the property image embedding; and
filtering the property image if similarity score meets a threshold.

5. The method of claim 4, wherein the first category of keywords is damage keywords, and the second category of keywords is non-damage keywords.

6. The method of claim 5, wherein the threshold is if the similarity score for non-damage keywords is higher than the similarity score for damage keywords.

7. The method of claim 1, wherein the vector embedding is multi-vector embedding and each property image is represented as a set of token-level vectors.

8. The method of claim 1, wherein the number of clusters in each category is the square root of the number of properties in the category.

9. A system for natural disaster damage analysis comprising:
a processor; and
a memory storing computer-readable instructions that, when executed by the processor, cause the system to:
convert a set of aerial images into a set of property images;
cluster the set of property images using vector embedding, wherein cluster includes:
classify the property images into separate categories;
determine a symmetric similarity between the property images in each category; and
cluster the property images based on the similarity;
extract damage information from a set of representative members of the clustered property images, wherein the damage information includes damage level information and damage reasoning information; and
store the damage information into a datastore with at least two databases, wherein at least one of the databases stores damage reasoning information and at least one other one of the databases stores damage level information.

10. The system of claim 9, the instructions further comprising:
process a query from a user;
retrieve from the datastore using the processed information;
generate a prompt with the retrieved information and the query attached to the prompt; and
generate a response using the prompt and the retrieved information and the query.

11. The system of claim 9, wherein the instruction to cluster is done by hierarchical agglomerative clustering.

12. The system of claim 9, wherein the instruction to classify includes:
convert the property image into an embedding;
convert a first category of keywords and a second category of keywords into embeddings;
generate a similarity score for each category of keywords and between each category of keywords embedding and the property image embedding; and
filter the property image if similarity score meets a threshold.

13. The system of claim 12, wherein the first category of keywords is damage keywords, and the second category of keywords is non-damage keywords.

14. The system of claim 13, wherein the threshold is if the similarity score for non-damage keywords is higher than the similarity score for damage keywords.

15. The system of claim 12, wherein the vector embedding is multi-vector embedding and each property image is represented as a set of token-level vectors.

16. A computer program product comprising a non-transitory computer-readable storage medium containing computer program code, the computer program code when executed by one or more processors causes the one or more processors to perform operations, the computer program code comprising instructions to:
convert a set of aerial images into a set of property images;
cluster the set of property images using vector embedding, wherein cluster includes:
classify the property images into separate categories;
determine a symmetric similarity between the property images in each category; and
cluster the property images based on the similarity;
extract, by a first artificial intelligence (AI) agent, damage information from a set of representative members from the clustered property images, wherein the damage information includes damage level information and damage reasoning information; and
store the damage information into a datastore with at least two databases, wherein at least one of the databases stores damage reasoning information and at least one other one of the databases stores damage level information.

17. The computer program product of claim 16, wherein the computer program code further comprising:
process, by a query planner, a query from a user;
retrieve from the datastore using the processed information;
generate a prompt with the retrieved information and the query attached to the prompt; and
generate a response using the prompt and the retrieved information and the query.

18. The computer program product of claim 16, wherein the instructions to cluster is done by hierarchical agglomerative clustering.

19. The computer program product of claim 16, wherein the instructions to classify includes:
convert the property image into an embedding;
convert a first category of keywords and a second category of keywords into embeddings;
generate a similarity score for each category of keywords and between each category of keywords embedding and the property image embedding; and
filter the property image if similarity score meets a threshold.

20. The non-transitory computer program product of claim 19, wherein the vector embedding is multi-vector embedding and each property image is represented as a set of token-level vectors.
